(19) United States
(12) Patent Application Publication
(10) Pub. No.: US 2021/0327287 A1
(43) Pub. Date: Oct. 21, 2021

(54) UAV PATH PLANNING METHOD AND DEVICE GUIDED BY THE SAFETY SITUATION, UAV AND STORAGE MEDIUM

(71) Applicant: Beihang University, Beijing (CN)

(72) Inventors: Xianbin Cao, Beijing (CN); Wenbo Du, Beijing (CN); Yakun Zhao, Beijing (CN); Lei Zheng, Beijing (CN); Liang Xu, Beijing (CN)

(73) Assignee: Beihang University, Beijing (CN)

(21) Appl. No.: 17/102,966

(22) Filed: Nov. 24, 2020

(30) Foreign Application Priority Data
Apr. 15, 2020 (CN) 202010296424.2

(51) Int. Cl. G08G 5/00; G05D 1/10; B64C 39/02

(52) U.S. Cl. CPC G08G 5/0034; B64C 39/024; G08G 5/0069; G05D 1/106

(57) ABSTRACT

This disclosure provides an UAV path planning method and device guided by the safety situation, UAV and storage medium, the method comprising: acquiring the image in the front view of the UAV, determining the type(s) of obstacle(s) and threat degree corresponding to each area, obtaining the coordinates of the obstacle(s) relative to the UAV in each area in the front view of the UAV and the distance from the obstacles in each area to the UAV, calculating the safety situation of each area according to the threat degree and distance corresponding to each area, calculating the cost data corresponding to each area according to the distance from each area to the target location and the safety situation of each area, determining the flight direction of the UAV according to the area with the minimum cost data.

### CROSS-REFERENCE TO RELATED APPLICATIONS

This application claims priority to Chinese Patent Application No. 202010296424.2, filed on Apr. 15, 2020, which is hereby incorporated by reference in its entirety.

### TECHNICAL FIELD

The application relates to the automatic navigation of the unmanned aerial vehicle (UAV), and particularly relates to an UAV path planning method and device guided by the safety situation, UAV and storage medium.

### BACKGROUND

Nowadays, although there has been a lot of research on the problem of UAV path planning, most algorithms still have certain limitations. Among them: some algorithms rely entirely on the acquisition of the global information, which is difficult to obtain in unknown environments; some algorithms rasterize the network without considering the special mobility of the UAV and the limitations of actual scenes; Some algorithms take existing paths as prerequisite information, which is not practical in real-life applications.

### SUMMARY

This disclosure provides an UAV path planning method and device guided by the safety situation, UAV and storage medium, wherein the UAV path planning method that can calculate and determine the safety situation based on the actual environment of the scene to plan the flight direction of the UAV.

This disclosure provides an UAV path planning method guided by the safety situation, this method comprising:

acquiring the image in the front view of the UAV, processing the image to obtain the type(s) of obstacle(s) in each area of the image and determining the threat degree of each area based on the type(s) of the obstacle(s);

obtaining the coordinates of the obstacle(s) relative to the UAV in each area in the front view of the UAV, and calculating the distance from the obstacle(s) in each area to the UAV according to the coordinates;

calculating the safety situation of each area according to the threat degree and the distance corresponding to each area;

calculating the cost data corresponding to each area according to the distance from each area to the target location and the safety situation corresponding to each area;

determining the flight direction of the UAV according to the area with the minimum cost data.

Optionally, processing the image to obtain the type(s) of the obstacle(s) in each area in the view, comprising: processing the image by a deep learning algorithm to obtain the type(s) of the obstacle(s) in each area in the view.

Optionally, determining the threat degree of each area based on the type(s) of the obstacle(s) in each area, comprising:

determining the threat level corresponding to each area according to the type(s) of the obstacle(s) in each area;

determining the threat degree corresponding to the area according to the threat level corresponding to the area.

Optionally, if there is no obstacle in an area, determining whether the distance from the area to the nearest obstacle(s) is less than the safety radius;

in the case where the distance from the area to the nearest obstacle(s) is less than the safety radius, determining the threat degree of the area according to the type(s) of the nearest obstacle(s);

wherein: the threat degree of that area is smaller than the threat degree of the area where the nearest obstacle(s) is located.

Optionally, obtaining the coordinates of the obstacle(s) relative to the UAV in each area in the front view of the UAV, comprising:

obtaining the coordinates of the obstacle(s) relative to the UAV in each area in the front view of the UAV at multiple moments;

the method further comprises: determining the moving speed of the obstacle(s) in each area according to the coordinates at multiple moments;

determining the threat degree of each area based on the type(s) of the obstacle(s), comprising:

determining the threat degree of each area base on the type(s) and speed of the obstacle(s).

Optionally, the area is an area determined according to a rectangular sub-image in the image, or an area divided according to the obstacle(s) in the image.

Optionally, the method further comprises: determining the corresponding display color according to the safety situation of each area;

combining the display color to generate a safety situation layer and displaying the safety situation layer.

This disclosure also provides a safety-situation-guided UAV path planning device, comprising:

a first processor, configured to obtain the image in the front view of the UAV, process the image to obtain the type(s) of obstacle(s) in each area in the view of the UAV, and determine the threat degree of each area based on the type(s) of obstacle(s) in the area;

a second processor, configured to obtain the coordinates of the obstacle(s) relative to the UAV in each area in the front view of the UAV, and calculate the distance from the obstacle(s) in each area to the UAV according to the coordinates;

a third processor, configured to calculate the safety situation of each area according to the threat degree and distance corresponding to each area;

a fourth processor, configured to calculate the cost data corresponding to each area according to the straight-line distance from the obstacle(s) in each area to the target location and the safety situation of each area;

a fifth processor, configured to determine the flight direction of the UAV in the next cycle according to the area with the minimum cost data.

This disclosure also provides an UAV, comprising a camera, a distance measurement device, and a digital processor;

the camera is configured to obtain an image in the front view of the UAV;

the distance measurement device is configured to obtain the distance from the obstacle(s) to the UAV in each area in the front view of the UAV;

the processor is configured to: process the image to obtain the type(s) of the obstacle(s) in each area in the view, determine the threat degree of each area based on the type(s) of obstacle(s) in each area, calculate the safety situation of each area according to the threat degree and the distance corresponding to each area, calculate the cost data corresponding to each area based on the straight-line distance from the UAV to the target location and the safety situation corresponding to each area, and, determine the flight direction of the UAV in the next cycle based on the area with the minimum cost data.

This disclosure further provides a storage medium, comprising a memorizer and a processor; the memorizer stores the code of the program; the processor loads the program code and executes the method as described above.

The UAV path planning method provided in this disclosure can complete the path planning task in real time based on the data obtained by the camera and lidar, without knowing the global information and the position of obstacle(s) in advance, and can adapt to the needs of scenarios where the environmental characteristics change randomly. In addition, the method provided in this disclosure processes the image by artificial intelligence algorithms, identify the type(s) of the obstacle(s) and determines the threat degree of each area based on the type(s) of obstacle(s), so that different types of obstacles have different threat degrees, it also makes the UAV flight path, which is generated based on the type(s) of obstacle(s) in the actual scene, more in line with the characteristics of the specific scene.

In the application, the above technical schemes can be combined with each other to realize more preferred combination schemes. Other features and advantages of the application will be described in a subsequent specification, and some of the advantages may become apparent from the specification or be understood by implementing the application. The object and other advantages of the application can be realized and obtained through the contents specially pointed out in the specification and the drawings.

### BRIEF DESCRIPTION OF DRAWINGS

The attached figures are only for the purpose of illustrating specific embodiments, and are not considered to be a limitation of the application. In the whole figures, the same reference symbols represent the same parts.

FIG. 1 is a schematic structural diagram of an UAV in the embodiment.

FIG. 2 is a flow chart of a method for the UAV path-planning method in the embodiment.

FIG. 3 is a schematic structural diagram of an UAV path planning device in the embodiment.

### DESCRIPTION OF EMBODIMENTS

The preferred embodiments of the application will be described below in combination with the attached figures in detail, where the attached figures form part of the application and, together with the embodiments of the application, are used to explain the principles of the application, not to define the scope of the application.

The embodiment of the present description provides a UAV path planning method. Before introducing the path planning method provided by the embodiment of the present description, the configuration of the UAV of the embodiment is introduced.

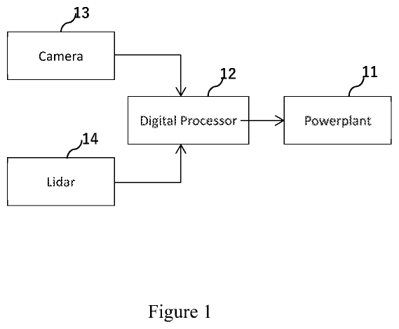

FIG. 1 is a schematic structural diagram of an UAV provided by the embodiment. As shown in FIG. 1, the UAV provided in this embodiment comprises a power device 11, a digital processor 12, a camera 13 and a lidar 14. The digital processor 12 can process the image taken by the camera 13 and process the obstacle position data determined by the scanning of the lidar 14, generate a flight control instruction based on the data obtained by processing the image and the obstacle data, and control the power device 11 according to the flight control instruction, then realize the automatic path planning of the UAV.

The device for determining the position data of the obstacle(s) used on the UAV in the embodiment of the present disclosure is the lidar 14. In other embodiments, it may also be other devices known in the area such as a binocular camera.

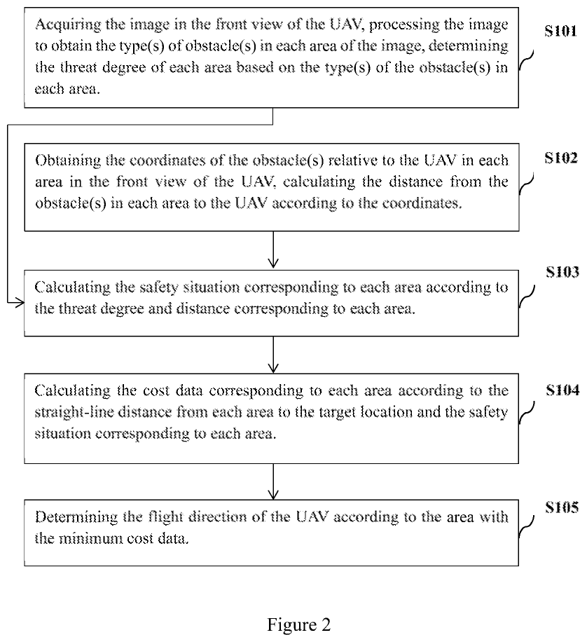

FIG. 2 is the UVA path planning method provided by an embodiment. Wherein, The UAV determines flight direction according to this method. The flight direction mentioned here is just a flight direction for a small period of time in the future, not the direction that the UAV always follows when flying to the target location. As shown in FIG. 2, the path planning method provided in this embodiment comprises steps S101-S105.

S101: Obtaining the image in the front view of the UAV, processing the image to obtain the type(s) of obstacle(s) in each area in the view, and determining the threat degree of each area based on the type(s) of the obstacle(s) in each area.

When step S101 is executed, the camera 13 on the UAV shoots the front view to form an image, and sends it to the processor 12. The processor 12 analyzes and processes the image according to the internally stored artificial intelligence algorithm to determine the type(s) of the obstacle(s); in specific applications, the aforementioned artificial intelligence algorithm is preferably a deep learning algorithm.

After being processed by the artificial intelligence algorithm, the processor 12 can determine the type(s) of the obstacle(s) in the image. In a specific deep learning algorithm, the type of obstacle can be determined according to the shape, color, and size features of the obstacle.

In a specific application, the types of obstacles may include fixed objects, slow moving objects, and fast moving objects.

Different types of obstacles have different motion properties. For example: the fixed object is fixed in a position and does not move; in practical applications, it could be building, telephone pole or tree; of course, because the branches of the tree have the property of drifting with the wind, it can also be considered as a slow moving object; Under normal circumstances, pedestrians or some animals can be considered as slow moving objects; while vehicles on the road, pedestrians driving bicycles or motorcycles can be considered as fast moving objects.

In the illustrated embodiment, each type of obstacle is marked with a corresponding threat level threat (threat is an integer ranging from 1 to above according to the specific type of the obstacle. The more threatening the obstacle is, the higher threat would be), and the threat degree d (O) of the obstacle can be determined according to the threat level. For example, in an application

$$d ( O ) = 1 - \frac{1}{threat} , d ( {O}_{i} ) ∈ [ 0 , 1 ) .$$

In the embodiment of the present disclosure, each of the aforementioned areas is an area in the view of the camera 13. In specific applications, there are several options for dividing the area.

(1) The method of rectangular grid division, that is, the area corresponding to the rectangle composed of multiple pixels in the image is considered as the aforementioned area; in specific applications, the rectangle corresponding to m×n pixel blocks can be considered as a local area. If the imaging resolution of the camera 13 is x×y, the area that can be determined is o×p,

$$o = ⌈ \frac{x}{m} ⌉ , p = ⌈ \frac{y}{n} ⌉ .$$

In practical applications, m and n are preferably set to integers greater than 1, in order to reduce the range of the divided area as much as possible and increase the processing speed.

(2) Dividing according to the edge type(s) of obstacle(s). Specifically, the edge(s) of the obstacle(s) in the image can be determined according to the artificial intelligence algorithm, and the view of camera 13 is divided into multiple larger areas according to the obstacle at the edge of the image; subsequently, the non-obstacle area is divided to form Multiple areas.

In the case where the area is divided by rectangular grid, the threat degree of each area within the view of camera 13 can be expressed as

$$[ \begin{matrix}{S}_{11} & … & {S}_{1 p} \\ ⋮ & ⋱ & ⋮ \\ {S}_{o 1} & … & {S}_{o p}\end{matrix} ] ,$$

if a certain area(i,j) is the area where an obstacle O_{A} is located, then S_{(i,j)}=d (O_{A}).

S102: Obtaining the coordinates of obstacles relative to the UAV in each area in the front view of the UAV, and calculating the distance from the obstacle(s) in each area to the UAV according to the coordinates.

In step S102, the lidar 14 scans each area in the front view of the UAV, and determines the coordinates of each part of the obstacle(s) relative to the UAV according to the reflection result, and thus determines the coordinates of obstacle(s) in each area relative to the UAV.

It should be noted that, in order to realize the function of step S102, the shooting angle of camera 13 and the scanning area of lidar 14 should be corrected and matched, so that the coordinates(x,y,z) of the obstacle(s) relative to the UAV can be determined.

In order to achieve the aforementioned function, in this embodiment, to establish a three-dimensional coordinate system, the focal point of the camera 13 on the UAV is taken as the origin of coordinates, the optical axis of the camera 13 is taken as the z-axis of the UAV coordinate system, and the x direction of the camera 13 is taken as the x-axis of the UAV coordinate system, the y-direction of the camera 13 is taken as the y-axis of the UAV coordinate system; and, according to the position of the Lidar 14 relative to the camera 13 and the angle of the Lidar 14 relative to the optical axis of the camera 13, the data obtained by the Lidar 14 is transformed and converted into the coordinate system of the UAV.

In the case where the area is divided by rectangular grid, the straight-line distance of obstacle(s) in each area in the view of camera 13 can be expressed as

$$[ \begin{matrix}{Z}_{11} & … & {Z}_{1 p} \\ ⋮ & ⋱ & ⋮ \\ {Z}_{o 1} & … & {Z}_{o p}\end{matrix} ] ,$$

wherein: the corresponding Zᵢⱼ of a certain area (i,j) is the distance from the obstacle to the UAV in this area. Hence, the z-axis coordinate of the obstacle(s) in each area can be expressed as

$$[ \begin{matrix}{z}_{11} & … & {z}_{1 p} \\ ⋮ & ⋱ & ⋮ \\ {z}_{o 1} & … & {z}_{o p}\end{matrix} ] ,$$

wherein: the corresponding zᵢⱼ of a certain area (i,j) is the z-axis coordinate of the corresponding obstacle. It should be noted that the correspondence between Z and z should match the proportion of that of the other two axes.

After determining the coordinates (x,y,z) of each part of the obstacle relative to the UAV, determine the distance from the obstacle(s) in each area to the UAV by \sqrt{x²+y²+(z)²}. It should be noted that the aforementioned distance is at most the effective scanning distance of the Lidar 14; when there are no obstacle(s) in the area, or the obstacle(s) distance is greater than the effective scanning distance of the Lidar 14, the aforementioned distance is the Lidar 14 effective scanning distance.

In practical applications, calculate the distance from the obstacle(s) in each area to the UAV according to the coordinates. The distance from the closest point in each area to the UAV can be considered as the distance from the obstacle(s) to the UAV in this area.

It should be noted that there is no order between the aforementioned step S101 and step S102, the execution order of the two steps may be reversed, or the two steps may be executed in parallel.

S103: Calculating the safety situation of each area according to the threat degree and distance corresponding to each area.

In this embodiment, the safety situation is the impact that obstacle(s) in each area may have on the flight safety of the UAV. The safety situation is related to the type(s) of obstacle(s) and the distance from the obstacle(s) to the current position of the UAV, and the type(s) of the obstacle(s) can be expressed by the threat degree. Therefore, in this embodiment, the threat degree and distance corresponding to each area can be used to calculate safety situation.

In this embodiment, the safety situation of each area within the view of the camera 13 can be expressed by

$$[ \begin{matrix}{t}_{11} & … & {t}_{1 p} \\ ⋮ & ⋱ & ⋮ \\ {t}_{o 1} & … & {t}_{o p}\end{matrix} ] , {t}_{i j} = {S}_{i j} \times \frac{1}{{z}_{i j}} .$$

The safety situation of each area is proportional to the threat degree, and inversely proportional to the distance from obstacle(s) to the UAV; that is, the larger tᵢⱼ is, the less secure the safety situation represents.

In other embodiments, other calculation methods may also be used to comprehensively consider the threat degree and distance to calculate the safety situation of each area.

S104: Calculating the cost data corresponding to each area according to the straight-line distance from each area to the target location and the safety situation corresponding to each area.

S105: Determining the flight direction of the UAV according to the area with the minimum cost data.

In step S104, the parameters for calculating the cost data include two parts: (1) the straight-line distance from the obstacle(s) coordinates in each area to the target position; (2) the safety situation corresponding to each area.

In a specific application of the embodiment of this disclosure, the coordinate data of the target location is (X_{goal}, y_{goal}, z_{goal}). The cost data of each area (i,j) can be obtained by the formula \sqrt{(xᵢⱼ−x_{goal})²+(yᵢⱼ−y_{goal})²+(zᵢⱼ−z_{goal})²}×tᵢⱼ. According to the foregoing formula, if the distance between a certain area and the target location is smaller, and the safety situation of a certain area is smaller, hence the cost data calculated in this area is smaller.

In step S105, the flight direction of the UAV is determined according to the area with the minimum cost data, starting from the current position of the UAV and aiming at the point with the minimum cost data as the end point to form a vector. The direction of this vector is the flight direction of the UAV.

After determining the flight direction of the UAV, making the UAV to fly a certain distance according to this flight direction. It should be noted that the flying distance of the UAV in this flight direction is less than the length of the aforementioned vector.

After the UAV executes the aforementioned steps S101-S105 and flies to a new position, it may execute the aforementioned steps S101-S105 again until reaching the target location.

The UAV path planning method provided in this embodiment, comprising, determining the type(s) of obstacle(s) by using an artificial intelligence algorithm on the image captured by the camera 13, and determining the threat degree of the flyable area in each area in the view based on the type(s) of the obstacle(s), calculating to obtain the safety situation of each area according to the threat degree and the distance from the obstacle(s) to the UAV, and calculating the cost data of each area based on the safety situation and the distance from the obstacle(s) in each area to target location and then determining the flight direction of the UAV based on the position of the area with the minimum cost data.

The UAV path planning method provided in this embodiment can complete the path planning process in real time based on the data acquired by the camera 13 and the lidar 14, without knowing the global information and the position of the obstacle(s) in advance, and can adapt to the needs of scenarios where the environmental characteristics change randomly.

In addition, the method provided in this embodiment processes the image by an artificial intelligence algorithm, identifies the type(s) of obstacle(s) and determines the threat degree of each area based on the type(s) of the obstacle(s), so that different types of the obstacles have different threat degrees, and also making the UAV flight path determined based on the style(s) of the obstacle(s) in practical scene more in line with the characteristics of the specific scene.

In this embodiment, when there is no obstacle in a certain area, the threat degree of this area is set to 0 accordingly. However, in practical applications, even if there is no obstacle in a certain area, since this area may be very close to the obstacle(s), if the UAV is flying to this area, it may still have a certain degree of danger. To solve this problem, in some embodiments of the present disclosure, determining the threat degree of each area based on the type(s) of obstacle(s) in each area in step S101 may further comprise steps S1011-S1015.

S1011: Determining whether there is an obstacle in the area; if yes, execute S1012; if not, execute S1013.

S1012: Determining the threat degree of an area according to the type(s) of obstacles(s) in the area.

S1013: Determining whether the distance from an area to the nearest obstacle(s) is less than the safety radius; if yes, execute S1014; if not, execute S1015.

S1014: Determining the threat degree of an area according to the type(s) of the nearest obstacle(s).

S1015: Determining that the threat degree of the obstacle is 0.

In specific applications of other embodiments, determining threat degree of the area according to the type(s) of the nearest obstacle(s) mentioned in step S1014 should ensure that the threat degree of this area is less than the threat degree of the area where the nearest obstacle(s) is located. For example, in practical applications, the threat degree of this area can be set to 0.5 times of the threat degree of the area where the nearest obstacle is located.

In other embodiments of this disclosure, other methods can also be used to determine the threat degree of each area, wherein: when acquiring the coordinates of obstacle(s) relative to the UAV in each area in the front view of the UAV, it should acquire the coordinates of the obstacle(s) relative to the UAV in each area in the front view of the UAV at multiple moments; it should be noted that the aforementioned multiple moments should be multiple moments with small time intervals. Subsequently, determine the moving speed of the obstacle(s) in each area according to the coordinates at multiple times. Subsequently, determine the threat degree of each area based on the type(s) of obstacle(s) and the moving speed of the obstacle(s). That is to say, in some embodiments, the threat degree of the obstacle(s) is directly related to the moving speed of the obstacle(s). The greater the moving speed of the obstacle(s) is, the greater the corresponding threat degree is.

In addition to the foregoing steps S101-S105, other solutions of this embodiment may further comprise step S106.

S106: Determining the corresponding display color according to the safety situation of each area, combining display colors to form a safety situation layer, and displaying the aforementioned safety situation layer.

In specific applications, determine the display color of each area according to the safety situation of the corresponding area. If the safety situation is 0, the display color can be set to green; if the safety situation is tᵢⱼ≠0, and the safety situation value is in the first 70% of all regions whose safety situation is not 0, the corresponding display color is set to red; while the display color of other areas gradually changes from green to red as its safety situation changes from small to large.

In practical applications, the safety situation layer can be set as a mask layer, and this mask layer are superimposed and displayed with the original image.

The aforementioned safety situation layer can be displayed and showed to the user, so that the user can understand the status of the flying environment of the UAV in real time, and enable the user to intervene to control the flying state of the UAV in due time.

In addition to providing the aforementioned UAV path planning method guided by the safety situation, this embodiment also provides a UAV path planning device. Because the UAV path planning device adopts the same inventive concept as the aforementioned method, only the structure of this path planning device will be described below. For the technical effects and technical problems solved by its specific application, please refer to the previous statement.

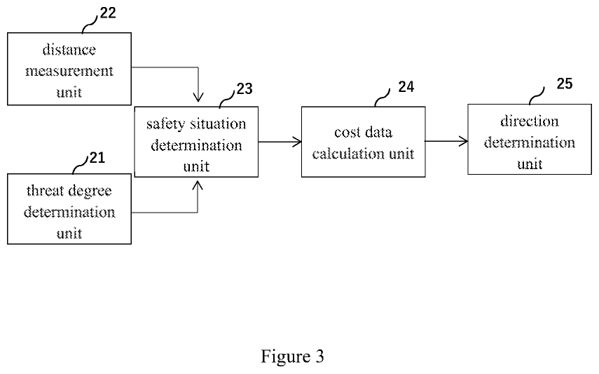

FIG. 3 is a schematic structural diagram of a UAV path planning device provided by an embodiment. As shown in FIG. 3, this device includes a threat degree determination unit 21, a distance measurement unit 22, a safety situation determination unit 23, a cost data calculation unit 24, and a direction determination unit 25. Wherein the threat degree determination is implemented by a first processor, the distance measurement is implemented by a second processor, the safety situation determination is implemented by a third processor, the cost data calculation is implemented by a fourth processor and the direction determination is implemented by a fifth processor. Each of the first processor, the second processor, the third processor, the fourth processor, the fifth processor and the sixth processor is independent processor, or all of them are integrated in a single processor.

The threat degree determination unit 21 is configured to obtain the image in the front view of the UAV; process the image to obtain the type(s) of obstacle(s) in each area within the view, and determine the threat degree of each area based on the type(s) of the obstacle(s) in each area.

The distance measuring unit 22 is configured to obtain the coordinates of obstacle(s) relative to the UAV in each area in the front view of the UAV, and calculate the distance from obstacle(s) in each area to the UAV according to the coordinates.

The safety situation determination unit 23 is configured to calculate the safety situation of each area according to the threat degree and distance corresponding to each area.

The cost data calculation unit 24 is configured to calculate the cost data corresponding to each area according to the straight-line distance from the obstacle(s) in each area to the target location and the safety situation corresponding to each area.

The direction determination unit 25 is configured to determine the flight direction of the UAV in the next cycle according to the area with the minimum cost data.

The first processor is further configured to process the image by a deep learning algorithm to obtain the type(s) of the obstacle(s) in each area in the view.

Wherein the first processor is further configured to: determine the threat level corresponding to each area according to the type(s) of obstacle(s) in each area; determine the threat degree corresponding to the area according to the threat level of the area.

if there is no obstacle in an area, determining whether the distance from the area to the nearest obstacle(s) is less than the safety radius; in the case where the distance from the area to the nearest obstacle(s) is less than the safety radius, determining the threat degree of the area according to the type(s) of the nearest obstacle(s); wherein: the threat degree of the area is smaller than the threat degree of the area where the nearest obstacle(s) is(are) located.

wherein the second processor is further configured to: obtain the coordinates of the obstacle(s) relative to the UAV in each area in the front view of the UAV at multiple moments; the device further comprising: determining moving speed of the obstacle(s) in each area according to the coordinates at multiple moments; the first processor is also configured to determine the threat degree of each area based on the type(s) and speed of the obstacle(s).

Wherein the area is an area determined according to a rectangular sub-image in the image, or an area divided according to the obstacle(s) in the image.

The device further comprising a sixth processor configured to: determine the corresponding display color according to the safety situation of each area; combine the display color to generate a safety situation layer and displaying the safety situation layer. In addition to providing the foregoing method and device, this embodiment also provides a UAV. The UAV comprises a camera 13, a distance measurement device, and a digital processor 12.

The camera 13 is configured to obtain the image in the front view of the UAV; the distance measurement device is configured to obtain the distance from the obstacle(s) to the UAV in each area in the front view of the UAV; the digital processor 12 is configured to: process the image to obtain the type(s) of obstacle(s) in each area in the view, determine the threat degree of each area based on the type(s) of the obstacle(s) in each area, calculate the safety situation of each area according to the threat degree and distance corresponding to each area, calculate the cost data corresponding to each area according to the straight-line distance and the safety situation corresponding to each area; and determine the flight direction of the UAV in the next cycle according to the area with the minimum cost data.

In addition, an embodiment of this present disclosure also provides a storage medium where the program code stored in; after the foregoing program code is loaded, the storage medium may be used to perform the UAV path planning method mentioned in the foregoing embodiment.

Those specialist in the area may understand that all or part of the process of implementing the method in the above embodiments may be completed by a computer program instructing relevant hardware, and the program may be stored in a readable computer storage medium. Wherein, the readable computer storage medium can be a magnetic disk, a light disk, a read-only storage memory or a random storage memory, etc.

The above is only a preferred embodiment of the application, but the scope of protection of the application is not limited to this. Any change or replacement that can be easily thought of by any person familiar with the technical field within the technical scope of the application shall be covered in the scope of protection of the application.

The foregoing descriptions of specific exemplary embodiments of the present application have been presented for purposes of illustration and description. They are not intended to be exhaustive or to limit the application to the precise forms disclosed, and obviously many modifications and variations are possible in light of the above teachings. The exemplary embodiments were chosen and described in order to explain certain principles of the application and their practical application, to thereby enable others skilled in the art to make and utilize various exemplary embodiments of the present application, as well as various alternatives and modifications thereof. It is intended that the scope of the application be defined by the Claims appended hereto and their equivalents.

What is claimed is:

1. An UAV path planning method guided by the safety situation, comprising:
acquiring the image in the front view of the UAV, processing the image to obtain the type(s) of obstacle(s) in each area of the image, and determining the threat degree of each area based on the type(s) of the obstacle(s);
obtaining the coordinates of the obstacle(s) relative to the UAV in each area in the front view of the UAV, and calculating the distance from the obstacle(s) in each area to the UAV according to their coordinates;
calculating the safety situation of each area according to the threat degree and the distance corresponding to each area;
calculating the cost data corresponding to each area according to the distance from each area to the target location and the safety situation corresponding to each area;
determining the flight direction of the UAV according to the area with the minimum cost data.

2. The method according to claim 1, wherein:
processing the image to obtain the type(s) of the obstacle(s) in each area in the view, comprising: processing the image by a deep learning algorithm to obtain the type(s) of the obstacle(s) in each area in the view.

3. The method according to claim 1, wherein, determining the threat degree of each area based on the type(s) of the obstacle(s) in each area, comprising:
determining the threat level corresponding to each area according to the type(s) of obstacle(s) in each area;
determining the threat degree corresponding to the area according to the threat level of the area.

4. The method according to claim 3, further comprising:
if there is no obstacle in an area, determining whether the distance from the area to the nearest obstacle(s) is less than the safety radius;
in the case where the distance from the area to the nearest obstacle(s) is less than the safety radius, determining the threat degree of the area according to the type(s) of the nearest obstacle(s);
wherein: the threat degree of the area is smaller than the threat degree of the area where the nearest obstacle(s) is(are) located.

5. The method according to any of claim 1, wherein:
obtaining the coordinates of the obstacle(s) relative to the UAV in each area in the front view of the UAV, comprising:
obtaining the coordinates of the obstacle(s) relative to the UAV in each area in the front view of the UAV at multiple moments;
the method further comprising: determining the moving speed of the obstacle(s) in each area according to the coordinates at multiple moments;
determining the threat degree of each area based on the type(s) of the obstacle(s), comprising:
determining the threat degree of each area based on the type(s) and speed of the obstacle(s).

6. The method according to any of claim 1, wherein:
the area is an area determined according to a rectangular sub-image in the image, or an area divided according to the obstacle(s) in the image.

7. The method according to any of claim 1, further comprising:
determining the corresponding display color according to the safety situation of each area;
combining the display color to generate a safety situation layer and displaying the safety situation layer.

8. An UAV path planning device guided by the safety situation, comprising:
a first processor, configured to obtain the image in the front view of the UAV, process the image to obtain the type(s) of obstacle(s) in each area in the view of the UAV, and determine the threat degree of each area based on the type(s) of the obstacle(s) in the area;
a second processor, configured to obtain the coordinates of the obstacle(s) relative to the UAV in each area in the front view of the UAV, and calculate the distance from the obstacle(s) in each area to the UAV according to the coordinates;
a third processor, configured to calculate the safety situation of each area according to the threat degree and distance corresponding to each area;
a fourth processor, configured to calculate the cost data corresponding to each area according to the straight-line distance from the obstacle(s) in each area to the target location and the safety situation of each area;
a fifth processor, configured to determine the flight direction of the UAV in the next cycle according to the area with the minimum cost data.

9. The device according to claim 8, wherein:
the first processor is further configured to process the image by a deep learning algorithm to obtain the type(s) of the obstacle(s) in each area in the view.

10. The device according to claim 8, wherein, the first processor is further configured to:
determine the threat level corresponding to each area according to the type(s) of obstacle(s) in each area;
determine the threat degree corresponding to the area according to the threat level of the area.

11. The device according to claim 10, the first processor is further configured to:
determine whether the distance from the area to the nearest obstacle(s) is less than the safety radius if there is no obstacle in an area;
determine the threat degree of the area according to the type(s) of the nearest obstacle(s) in the case where the distance from the area to the nearest obstacle(s) is less than the safety radius;
wherein: the threat degree of the area is smaller than the threat degree of the area where the nearest obstacle(s) is(are) located.

12. The device according to any of claim 8, wherein the second processor is further configured to:
obtain the coordinates of the obstacle(s) relative to the UAV in each area in the front view of the UAV at multiple moments;
the device further comprising: determining moving speed of the obstacle(s) in each area according to the coordinates at multiple moments;
the first processor is also configured to determine the threat degree of each area based on the type(s) and speed of the obstacle(s).

13. The device according to any of claim 8, wherein:
the area is an area determined according to a rectangular sub-image in the image, or an area divided according to the obstacle(s) in the image.

14. The device according to any of claim 8, further comprising a sixth processor configured to:
determine the corresponding display color according to the safety situation of each area;
combine the display color to generate a safety situation layer and displaying the safety situation layer.

15. An UAV, comprising a camera, a distance measurement device, and a digital processor;
the camera is configured to obtain the image in the front view of the UAV;
the distance measurement device is configured to obtain the distance from the obstacle(s) to the UAV in each area in the front view of the UAV;
the processor is configured to: process the image to obtain the type(s) of the obstacle(s) in each area in the view, determine the threat degree of each area based on the type(s) of the obstacle(s) in each area, calculate the safety situation of each area according to the threat degree and the distance corresponding to each area, calculate the cost data corresponding to each area based on the straight-line distance from the UAV to the target location and the safety situation corresponding to each area, and, determine the flight direction of the UAV in the next cycle based on the area with the minimum cost data.

16. A storage medium, wherein, the storage medium stores the program code; after the program code is loaded, it can be used to execute the method according to claim 1.
